(19) United States
(12) Patent Application Publication
(10) Pub. No.: US 2026/0026989 A1
(43) Pub. Date: Jan. 29, 2026

(54) Adjustable Toilet Device

(71) Applicant: Lora Hubbard, Bridgeville, PA (US)

(72) Inventor: Lora Hubbard, Bridgeville, PA (US)

(21) Appl. No.: 19/258,241

(22) Filed: Jul. 2, 2025

Related U.S. Application Data
(60) Provisional application No. 63/675,483, filed on Jul. 25, 2024.

(51) Int. Cl. A61G 7/10; A61G 7/02

(52) U.S. Cl. CPC A61G 7/1007; A61G 7/02

(57) ABSTRACT

An adjustable toilet device is disclosed, which is a toilet that can be raised and lowered by the user. The adjustable toilet device comprises a hydraulic system which is housed within the base of the toilet and surrounds the toilet drainage pipe. The drainage pipe has an accordion-style expander to allow the pipe to raise and lower with the toilet. The base of the toilet is also comprised of an accordion-style flange that surrounds the toilet to prevent a gap from being created when the toilet is raised. The hydraulic system raises the toilet vertically upwards to a certain point. Once said point is reached the toilet tilts forward to further assist the user in getting up from the toilet. Once the user is done, they can depress the handle completely to lower the toilet back into a normal position.

### CROSS REFERENCE TO RELATED APPLICATION

The present application claims priority to, and the benefit of, U.S. Provisional Application No. 63/675,483, which was filed on Jul. 25, 2024, and is incorporated herein by reference in its entirety.

### FIELD OF THE INVENTION

The present invention relates generally to the field of adjustable toilet devices. More specifically, the present invention relates to a height-adjustable toilet installed on a hydraulic, accordion-style base. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in adjustable toilet devices. Generally, people with physical disabilities due to old age, injuries, surgery, etc., may have trouble using a standard toilet by themselves. However, asking for assistance to use the bathroom can compromise independence and be unnecessarily time-consuming for a caregiver. Further, standard toilets sit too low to the ground for a person with leg and back issues to try and get themselves up and off the toilet if they can get seated. Additionally, modifications to bathrooms can be incredibly expensive and require significant investment and maintenance to function.

Accordingly, there is a demand for an improved adjustable toilet device that offers a way for elderly and disabled individuals to independently use the toilet. More particularly, there is a demand for an adjustable toilet device that enables users to raise or lower the toilet, along with having the option to adjust its angle, to make it easier to sit down and get up from the toilet.

Therefore, there exists a long felt need in the art for an adjustable toilet device that provides users with a height-adjustable toilet installed on a hydraulic, accordion-style base. There is also a long felt need in the art for an adjustable toilet device that enables users to raise or lower the toilet, along with having the option to adjust its angle, to make it easier to sit down and get up from the toilet. Further, there is a long felt need in the art for an adjustable toilet device that includes hand levers on either side of the toilet seat to easily operate the hydraulic functions. Moreover, there is a long felt need in the art for a device that offers a way for elderly and disabled individuals to independently use the toilet. Further, there is a long felt need in the art for an adjustable toilet device that can include the option for foot levers or pedals to accommodate those with upper body limitations. Finally, there is a long felt need in the art for an adjustable toilet device that can assist those with disabilities sitting down and getting up from the seat.

The subject matter disclosed and claimed herein, in one embodiment thereof, comprises an adjustable toilet device. The device is a toilet that can be raised and lowered by the user using a hydraulic system controlled by a hand lever on the side of the toilet seat. The adjustable toilet device comprises a hydraulic system which is housed within the base of the toilet and surrounds the toilet drainage pipe. The drainage pipe has an accordion-style expander to allow the pipe to rise and lower with the toilet. The base of the toilet is also comprised of an accordion-style flange that surrounds the toilet to prevent a gap from being created when the toilet is raised. The hydraulic system raises the toilet vertically upwards to a certain point. Once said point is reached the toilet tilts forward to further assist the user in getting up from the toilet. Once the user is done, they can depress the handle completely to lower the toilet back into a normal position. The angular adjustments ensure people can get up and sit down on the toilet with ease. The hand lever can be moved to the right or to the left of the seat per the user's preference. Further, the receivers for the hand lever are located on either side of the seat, as well.

In this manner, the adjustable toilet device of the present invention accomplishes all of the forgoing objectives and provides users with a device that enables users to raise or lower the toilet. The device is a height-adjustable toilet installed on a hydraulic, accordion-style base. The device includes hand levers and/or foot pedals.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an adjustable toilet device. The device is a toilet that can be raised and lowered by the user using a hydraulic system controlled by a hand lever on the side of the toilet seat. The hydraulic system raises the toilet vertically upwards to a certain point. Once said point is reached the toilet tilts forward to further assist the user in getting up from the toilet. Once the user is done, they can depress the handle completely to lower the toilet back into a normal position. The angular adjustments ensure people can get up and sit down on the toilet with ease.

In one embodiment, the adjustable toilet device provides users with a height-adjustable toilet installed on a hydraulic, accordion-style base. The device enables users to raise or lower a toilet, along with having the option to adjust its angle, to make it easier to sit down and get up from the toilet. Accordingly, the device offers a way for elderly and disabled individuals to independently use the toilet.

In one embodiment, the adjustable toilet device comprises a conventional flushable toilet that can be raised or lowered by the user, as well having the option to adjust the toilet's angle to make it more accessible for those with upper body limitations. Specifically, the toilet comprises a hydraulic system which is housed within the base of the toilet and surrounds the toilet drainage pipe.

In one embodiment, the drainage pipe has an accordion-style expander to allow the pipe to rise and lower with the toilet. The base of the toilet is also comprised of an accordion-style flange that surrounds the toilet to prevent a gap from being created when the toilet is raised.

In one embodiment, the hydraulic system includes a pump and cylinder, which is an actuator for the system. The hydraulic system also includes hydraulic fluid and a reservoir to hold the fluid, as well as tubes, pipes, and hoses to transport the fluid. The hydraulic system engages the pump and cylinder to raise the toilet vertically upwards to a certain point. Once said point is reached the toilet tilts forward to further assist the user in getting up from the toilet. Once the user is done, they can depress the handle completely to lower the toilet back into a normal position. The angular adjustments ensure people can get up and sit down on the toilet with case.

In one embodiment, the adjustable toilet device includes at least one hand lever which can be moved to the right or to the left of the toilet seat per the user's preference to easily operate the hydraulic functions of the device. Further, the receivers for the hand lever are located on either side of the toilet seat, as well. To activate the toilet device, a user would depress the hand lever which raises or lowers the device, as well as allows for angular adjustment. Once done with using the toilet, the user depresses the hand lever again and the toilet returns to its normal or original position.

In one embodiment, the adjustable toilet device includes optional foot levers or pedals to accommodate those with upper body limitations. Thus, instead of a hand lever, the user would operate the toilet device via a foot lever or pedal. Accordingly, depressing the foot lever allows a user to raise or lower the toilet device, as well as provide for angular adjustment. Then, once done, the user depresses the foot lever again and the toilet returns to its normal or original position.

In yet another embodiment, the adjustable toilet device comprises a plurality of indicia.

In yet another embodiment, a method of adjusting a height and angle of a toilet is disclosed. The method includes the steps of providing an adjustable toilet device comprising a hydraulic system within a base of a toilet. The method also comprises pressing a hand lever to raise the toilet vertically upwards. Further, the method comprises tilting the toilet forward. The method also comprises utilizing the toilet with ease. Finally, the method comprises depressing the hand lever to lower the toilet back into anormal position.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a perspective view of one embodiment of the adjustable toilet device of the present invention showing the hand levers in accordance with the disclosed architecture;

FIGS. 2A-B illustrate a perspective view of one embodiment of the adjustable toilet device of the present invention showing the toilet elevated in accordance with the disclosed architecture;

FIGS. 3A-B illustrate a perspective view of one embodiment of the adjustable toilet device of the present invention showing the toilet tilted to front and back angles in accordance with the disclosed architecture;

FIG. 4 illustrates a perspective view of one embodiment of the adjustable toilet device of the present invention showing the hydraulic base in accordance with the disclosed architecture;

FIG. 5 illustrates a perspective view of one embodiment of the adjustable toilet device of the present invention showing the device in use in accordance with the disclosed architecture; and

FIG. 6 illustrates a flowchart showing the method of adjusting a height and angle of a toilet in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an adjustable toilet device that provides users with a height-adjustable toilet installed on a hydraulic, accordion-style base. There is also a long felt need in the art for an adjustable toilet device that enables users to raise or lower the toilet, along with having the option to adjust its angle, to make it easier to sit down and get up from the toilet. Further, there is a long felt need in the art for an adjustable toilet device that includes hand levers on either side of the toilet seat to easily operate the hydraulic functions. Moreover, there is a long felt need in the art for a device that offers a way for elderly and disabled individuals to independently use the toilet. Further, there is a long felt need in the art for an adjustable toilet device that can include the option for foot levers or pedals to accommodate those with upper body limitations. Finally, there is a long felt need in the art for an adjustable toilet device that can assist those with disabilities sitting down and getting up from the seat.

The present invention, in one exemplary embodiment, is a novel adjustable toilet device. The adjustable toilet device comprises a hydraulic system which is housed within the base of the toilet and surrounds the toilet drainage pipe. The drainage pipe has an accordion-style expander to allow the pipe to rise and lower with the toilet. The base of the toilet is also comprised of an accordion-style flange that surrounds the toilet to prevent a gap from being created when the toilet is raised. The hydraulic system raises the toilet vertically upwards to a certain point. Once said point is reached the toilet tilts forward to further assist the user in getting up from the toilet. Once the user is done, they can depress the handle completely to lower the toilet back into a normal position. The angular adjustments ensure people can get up and sit down on the toilet with case. The present invention also includes a novel method of adjusting a height and angle of a toilet. The method includes the steps of providing an adjustable toilet device comprising a hydraulic system within a base of a toilet. The method also comprises pressing a hand lever to raise the toilet vertically upwards. Further, the method comprises tilting the toilet forward. The method also comprises utilizing the toilet with ease. Finally, the method comprises depressing the hand lever to lower the toilet back into anormal position.

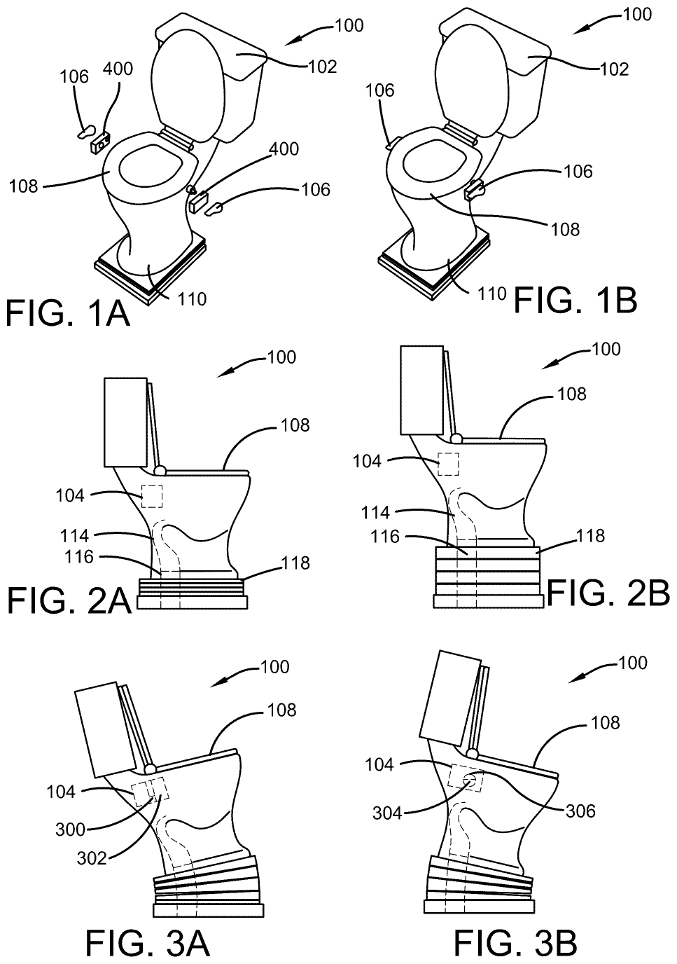

Referring initially to the drawings, FIGS. 1A-B illustrate a perspective view of one embodiment of the adjustable toilet device 100 of the present invention. In the present embodiment, the adjustable toilet device 100 is an improved adjustable toilet device 100 that provides a user 112 with a height-adjustable toilet 102 controlled by a hand lever 106 on the side of the toilet seat 108. Specifically, the adjustable toilet device 100 comprises a hydraulic system 104 positioned within a base 110 of the toilet component 102. The hydraulic system 104 raises the toilet component 102 vertically upwards to a certain point. Once said point is reached the toilet component 102 tilts forward to further assist the user 112 in getting up from the toilet 102. Once the user 112 is done, they can depress the hand lever 106 completely to lower the toilet 102 back into a normal position. The angular adjustments ensure people can get up and sit down on the toilet 102 with case.

Generally, the adjustable toilet device 100 provides users 112 with a height-adjustable toilet installed on a hydraulic, accordion-style base 110. The device 100 enables users 112 to raise or lower a toilet 102, along with having the option to adjust its angle, to make it easier to sit down and get up from the toilet 102. Accordingly, the device 100 offers a way for elderly and disabled individuals to independently use the toilet 102.

Further, the adjustable toilet device 100 comprises a conventional flushable toilet 102 that can be raised or lowered by the user 112, as well having the option to adjust the toilet's angle to make it more accessible for those with upper body limitations. Specifically, the toilet 102 comprises a hydraulic system 104 which is housed within the base 110 of the toilet 102 and surrounds the toilet drainage pipe 114.

As shown in FIGS. 2A-B, the drainage pipe 114 has an accordion-style expander 116 to allow the pipe 114 to raise and lower with the toilet 102. The base 110 of the toilet 102 is also comprised of an accordion-style flange 118 that surrounds the toilet 102 to prevent a gap from being created when the toilet 102 is raised.

As shown in FIGS. 3A-B, the hydraulic system 104 includes a pump 300 and cylinder 302, which is an actuator for the system 104. The hydraulic system 104 also includes hydraulic fluid 304 and a reservoir 306 to hold the fluid 304, as well as tubes, pipes, and hoses (not shown) to transport the fluid 304. The hydraulic system 104 engages the pump 300 and cylinder 302 to raise the toilet 102 vertically upwards to a certain point. Once said point is reached the toilet 102 tilts forward to further assist the user 112 in getting up from the toilet 102. Once the user 112 is done, they can depress the hand lever 106 completely to lower the toilet 102 back into a normal position. The angular adjustments ensure people can get up and sit down on the toilet 102 with case.

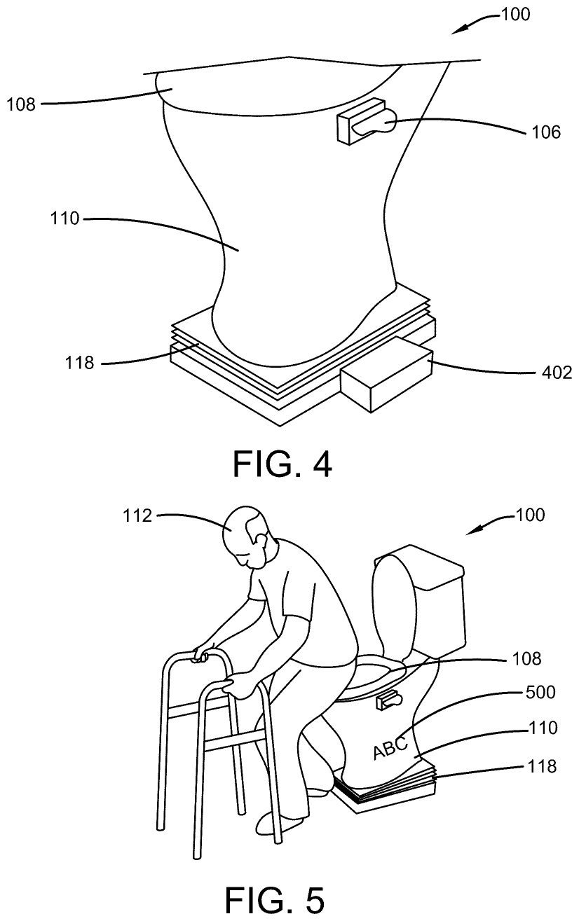

As shown in FIG. 4, the adjustable toilet device 100 includes at least one hand lever 106 which can be moved to the right or to the left of the toilet seat 108 per the user's preference to easily operate the hydraulic functions of the device 100. Further, the receivers 400 for the hand lever 106 are located on either side of the toilet seat 108, as well. To activate the toilet device 100, a user 112 would depress the hand lever 106 which raises or lowers the device 100, as well as allows for angular adjustment. Once done with using the toilet 102, the user 112 depresses the hand lever 106 again and the toilet 102 returns to its normal or original position.

Further, the adjustable toilet device 100 includes optional foot levers or pedals 402 to accommodate those with upper body limitations. Thus, instead of a hand lever 106, the user 112 would operate the toilet device 100 via a foot lever or pedal 402. Accordingly, depressing the foot lever 402 allows a user 112 to raise or lower the toilet device 100, as well as provide for angular adjustment. Then, once done, the user 112 depresses the foot lever 402 again and the toilet 102 returns to its normal or original position.

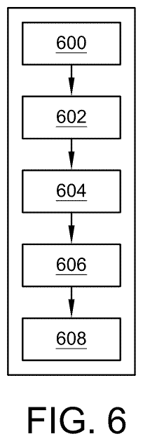

As shown in FIG. 5, the adjustable toilet device 100 comprises a plurality of indicia 500. The toilet component 102 of the device 100 may include advertising, a trademark, or other letters, designs, or characters, printed, painted, stamped, or integrated into the toilet component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be toilet, adjustability, or brand related.

FIG. 6 illustrates a flowchart of the method of adjusting a height and angle of a toilet. The method includes the steps of at 600, providing an adjustable toilet device comprising a hydraulic system within a base of a toilet. The method also comprises at 602, pressing a hand lever to raise the toilet vertically upwards. Further, the method comprises at 604, tilting the toilet forward. The method also comprises at 606, utilizing the toilet with case. Finally, the method comprises at 608, depressing the hand lever to lower the toilet back into anormal position.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “adjustable toilet device”, “toilet device”, “adjustable device”, and “device” are interchangeable and refer to the adjustable toilet device 100 of the present invention.

Notwithstanding the foregoing, the adjustable toilet device 100 of the present invention can be of any suitable size and configuration as is known in the art without affecting the overall concept of the invention, provided that it accomplishes the above stated objectives. One of ordinary skill in the art will appreciate that the adjustable toilet device 100 as shown in FIGS. 1-6 is for illustrative purposes only, and that many other sizes and shapes of the adjustable toilet device 100 are well within the scope of the present disclosure. Although the dimensions of the adjustable toilet device 100 are important design parameters for user convenience, the adjustable toilet device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An adjustable toilet device that provides a user with a height-adjustable toilet, the adjustable toilet device comprising:
a toilet component; and
a hydraulic system;
wherein the hydraulic system is housed within the toilet component; and
further wherein the hydraulic system acts to raise and lower the toilet component, as needed, to ensure users can get up and sit down on the toilet component with ease.

2. The adjustable toilet device of claim 1, wherein the toilet component comprises a conventional flushable toilet.

3. The adjustable toilet device of claim 2, wherein the hydraulic system is housed within a base of the toilet component and surrounds a toilet drainage pipe.

4. The adjustable toilet device of claim 3, wherein the toilet drainage pipe has an accordion-style expander to allow the toilet drainage pipe to raise and lower with the toilet component.

5. The adjustable toilet device of claim 4, wherein the base of the toilet component is also comprised of an accordion-style flange that surrounds the toilet component to prevent a gap from being created when the toilet component is raised.

6. The adjustable toilet device of claim 5, wherein the hydraulic system includes a pump and cylinder, which is an actuator for the hydraulic system.

7. The adjustable toilet device of claim 6, wherein the hydraulic system also includes hydraulic fluid and a reservoir to hold the hydraulic fluid, as well as tubes, pipes, and hoses to transport the hydraulic fluid.

8. The adjustable toilet device of claim 7, wherein the hydraulic system engages the pump and the cylinder to raise the toilet component vertically upwards to a certain point.

9. The adjustable toilet device of claim 8, wherein once the certain point is reached the toilet component tilts forward to further assist the user in getting up from the toilet component.

10. The adjustable toilet device of claim 9 further comprising at least one hand lever which can be positioned to a right or to a left of a toilet seat per a user's preference to easily operate the hydraulic functions of the adjustable toilet device.

11. The adjustable toilet device of claim 10, wherein receivers for the at least one hand lever are located on either side of the toilet seat, as well.

12. The adjustable toilet device of claim 11, wherein to activate the adjustable toilet device, a user would depress the at least one hand lever which raises or lowers the adjustable toilet device, as well as allows for angular adjustment.

13. The adjustable toilet device of claim 12, wherein once done with using the toilet component, the user depresses the at least one hand lever again and the toilet component returns to its normal or original position.

14. An adjustable toilet device that provides a user with a height-adjustable toilet, the adjustable toilet device comprising:
a toilet component which is a conventional flushable toilet; and
a hydraulic system;
wherein the hydraulic system is housed within a base of the toilet component and surrounds a toilet drainage pipe;
wherein the toilet drainage pipe has an accordion-style expander to allow the toilet drainage pipe to raise and lower with the toilet component;
wherein the base of the toilet component is also comprised of an accordion-style flange that surrounds the toilet component to prevent a gap from being created when the toilet component is raised;
wherein the hydraulic system engages a pump and a cylinder to raise the toilet component vertically upwards to a certain point;
wherein at least one hand lever is positioned to a right or to a left of a toilet seat per a user's preference to easily operate the hydraulic functions of the adjustable toilet device; and
further wherein the hydraulic system acts to raise and lower the toilet component, as needed, to ensure users can get up and sit down on the toilet component with ease.

15. The adjustable toilet device of claim 14, wherein to activate the adjustable toilet device, a user would depress the at least one hand lever which raises or lowers the adjustable toilet device, as well as allows for angular adjustment, and once done with using the toilet component, the user depresses the at least one hand lever again and the toilet component returns to its normal or original position.

16. The adjustable toilet device of claim 14 further comprising optional foot levers or pedals to operate the adjustable toilet device to accommodate those with upper body limitations.

17. The adjustable toilet device of claim 15, wherein depressing the optional foot levers or pedals allows a user to raise or lower the adjustable toilet device, as well as provide for angular adjustment.

18. The adjustable toilet device of claim 16, wherein once done, the user depresses the optional foot levers or pedals again and the toilet component returns to its normal or original position.

19. The adjustable toilet device of claim 14 further comprising a plurality of indicia.

20. A method of adjusting a height and angle of a toilet, the method comprising the following steps:
providing an adjustable toilet device comprising a hydraulic system within a base of a toilet;
pressing a hand lever to raise the toilet vertically upwards;
tilting the toilet forward;
utilizing the toilet with case; and
depressing the hand lever to lower the toilet back into a normal position.
